(19) United States
(12) Patent Application Publication
(10) Pub. No.: US 2021/0089007 A1
(43) Pub. Date: Mar. 25, 2021

(54) METHOD AND APPARATUS FOR IDENTIFYING AN ADDITIVELY MANUFACTURED WORKPIECE

(71) Applicant: SIEMENS AKTIENGESELLSCHAFT, MÜNCHEN (DE)

(72) Inventors: Hans Aschauer, München (DE); Kai Fischer, Baldham (DE); Markus Heintel, München (DE)

(21) Appl. No.: 16/633,781

(22) PCT Filed: May 15, 2018
(86) PCT No.: PCT/EP2018/062457

§ 371 Date: Jan. 24, 2020

(30) Foreign Application Priority Data
Jul. 27, 2017 (EP) 17183528.3

(51) Int. Cl. G05B 19/418

(52) U.S. Cl. CPC G05B 19/4183; G05B 2219/34215; G05B 2219/49299

(57) ABSTRACT

A method and a device, by which a customer/buyer of an additively manufactured workpiece can verify whether the quality of the printed workpiece matches the specifications prescribed by the manufacturer is provided. The manufacturer can in this case control and/or monitor in particular a number of authorized workpieces. In addition, in the event of damage, it can be proved whether a workpiece authorized by the manufacturer has been used.

### CROSS-REFERENCE TO RELATED APPLICATIONS

This application claims priority to PCT Application No. PCT/EP2018/062457, having a filing date of May 15, 2018, which is based on European Application No. 17183528.3, having a filing date of Jul. 27, 2017, the entire contents both of which are hereby incorporated by reference.

### FIELD OF TECHNOLOGY

The following relates to a method and an apparatus for identifying an additively manufactured workpiece.

### BACKGROUND

Additive manufacturing is becoming significant as a production method. The method allows for example spares no longer to be produced and stored centrally but rather to be created in situ when required. To this end, the manufacturer/product design owner/rights holder of the workpiece makes the design data available, and the workpiece can be created in situ by a printing service provider, for example. The design owner (rights holder) would like to inspect how frequently an applicable design is printed, however. In particular in the case of safety-critical parts, the aim is for in particular only parts authorized by the manufacturer to go into circulation and for unauthorized parts to be detected by the (end) customer.

In the past, there were already proof-of-concept attacks, in which the manipulation of model files was used to consciously reduce the quality of the additively manufactured workpiece and this meant that it no longer met the quality stipulations of the manufacturer. These alterations were not detectable by a user of the workpiece.

The prior art reveals the document U.S. Pat. No. 8,531,247 B2, the document U.S. Pat. No. 8,892,616 B2, the document U.S. Pat. No. 8,300,811 B2, the document U.S. Pat. No. 9,147,088 B2, the document EP 2 605 445 B1, the document EP 2 870 565 A1, the document EP 2 891 102 A1 and the document U.S. Pat. No. 8,843,761 B2.

US 2014/223583 A1 discloses a system and method for managing digital production, in particular 3D printing. The system comprises a reader that authenticates the workpiece following manufacture by comparing physical features with design stipulations. The workpiece can be certified if the quality of the production result is adequate.

Fadhel et al. “Approaches to maintaining provenance throughout the additive manufacturing process”, WORLD CONGRESS ON INTERNET SECURITY (WORLDCIS-2013), INFONOMICS SOCIETY, 9 Dec. 2013, pages 82-87, XP032572430, DOI:
10.1109/WORLDCIS.2013.6751022 describes approaches to a solution to maintain the indications of origin in the additive manufacturing process. The constraints to sign digital and physical objects are described.

### SUMMARY

An aspect relates to a method and an apparatus for identifying an additive workpiece.

In accordance with a first aspect, embodiments of the invention relate to a method for identifying an additively manufactured workpiece, having the method steps of:
a) capturing the additively manufactured workpiece by means of a capture device, wherein workpiece data about individual features of the additively manufactured workpiece are captured;
b) assigning the workpiece data to the additively manufactured workpiece;
c) comparing the workpiece data with reference data for the additively manufactured workpiece;
d) generating a digital certificate if dissimilarities in the workpiece data in comparison with the reference data are within a prescribed tolerance range.

Unless indicated otherwise in the description below, the terms “perform”, “calculate”, “computer-aided”, “compute”, “establish”, “generate”, “configure”, “reconstruct” and the like may relate to actions and/or processes and/or processing steps that alter and/or produce data and/or that convert data into other data, the data being able to be presented or available as physical variables, in particular, for example as electrical impulses. In particular, the expression “computer” should be interpreted as broadly as possible in order to cover in particular all electronic devices having data processing properties. Computers can therefore be for example personal computers, servers, programmable logic controllers (PLCs), handheld computer systems, pocket PC devices, mobile radios and other communication devices that can process data in computer-aided fashion, processors and other electronic devices for data processing.

Within the context of embodiments of the invention, “computer-aided” can be understood to mean for example an implementation of the method in which in particular a processor performs at least one method step of the method.

Within the context of embodiments of the invention, a “processor” can be understood to mean for example a machine or an electronic circuit. A processor can be in particular a central processing unit (CPU), a microprocessor or a microcontroller, for example an application-specific integrated circuit or a digital signal processor, possibly in combination with a memory unit for storing program commands, etc. A processor can for example also be an IC (integrated circuit), in particular an FPGA (field programmable gate array) or an ASIC (application-specific integrated circuit), or a DSP (digital signal processor) or a graphics processor GPU (graphics processing unit). A processor can also be understood to mean a virtualized processor, a virtual machine or a soft CPU. It can for example also be a programmable processor that is equipped with configuration steps for performing the method according to embodiments of the invention or that is configured by means of configuration steps such that the programmable processor produces the features according to embodiments of the invention for the method, the component, the modules or other aspects and/or subaspects of embodiments of the invention.

Within the context of embodiments of the invention, a “memory unit” or a “memory module” and the like can be understood to mean for example a volatile memory in the form of random access memory (RAM) or a permanent memory such as hard disk or a data carrier.

Within the context of embodiments of the invention, “providing” can be understood to mean for example loading or storing, for example on or from a memory module. “Providing” can in particular also be understood to mean transferring data (e.g. model data, workpiece data, digital certificate) between communication partners (e.g. the service provider and the rights holder).

Within the context of embodiments of the invention, “digital twin” can be understood to mean for example a digital image, in particular in the form of a data model or a data structure, of a real product, (technical) article or of a (physical) object. This can be produced in particular for the additively manufactured workpiece. In particular, the term digital twin is also explained in the following patent applications: WO2016/141998 or WO2017/045789.

The method or embodiments of the invention is advantageous in so far as a customer/purchaser of an additively manufactured workpiece can check whether the quality of the additively manufactured workpiece (e.g. a printed part) is concordant with the stipulations required by the manufacturer. The manufacturer can in particular inspect and/or monitor a number of authorized workpieces. Moreover, in particular in the event of damage, it is possible to prove whether a workpiece authorized by the manufacturer was used.

In a first embodiment of the method, producing of the additively manufactured workpiece and the capturing are performed by a service provider, wherein the assigning, the comparing and the generating are performed by a rights holder for the additively manufactured workpiece. To this end, the service provider may transmit the workpiece data to the rights holder.

The method is advantageous for in particular relocating the production of the additively manufactured workpiece to the service provider, but the rights holder of the workpiece can still check a quality of the additively manufactured workpiece.

In a further embodiment, the individual features are random artefacts of the production process.

The method is advantageous for in particular capturing unique features of the additively manufactured workpiece. This allows in particular a kind of digital fingerprint to be formed in a simple manner.

In a further embodiment of the method, the digital certificate indicates that the additively manufactured workpiece complies with the tolerance range.

The method is advantageous for in particular allowing a customer/purchaser of the additively manufactured workpiece to check that the additively manufactured workpiece complies with the tolerance range, for example.

In a further embodiment of the method, the workpiece data are taken as a basis for forming a unique identification value.

The method is advantageous for in particular calculating a unique identification value (e.g. a digital fingerprint) in a simple manner.

In a further embodiment of the method, the workpiece data and/or the unique identification value and/or the/an identification number are included in the digital certificate.

The method is advantageous for in particular facilitating checking of the additively manufactured workpiece. To this end, for example a customer/purchaser of the additively manufactured workpiece can use a web interface of the rights holder to check whether the latter has actually issued the digital certificate and/or the workpiece data and/or the unique identification value and/or the/an identification number. In particular, the identification number can be the unique identification value, or the identification number is included in the unique identification value. In the latter case, the identification number can be calculated again from the unique identification value.

In a further embodiment of the method, the unique identification value and/or the identification number are applied to the additively manufactured workpiece.

The method is advantageous for in particular facilitating the checking of the digital signature for a customer/purchaser of the additively manufactured workpiece. To this end, for example the unique identification value and/or the identification number can be applied to the additively manufactured workpiece as a sticker, a security seal. Alternatively, or additionally, for example the unique identification value and/or the identification number can also be incorporated into the workpiece (e.g. as an inscription, a stamped digit sequence etc.). Alternatively or additionally, in particular an RFID chip (e.g. included in a security seal), which is adhesively bonded to the additively manufactured workpiece or incorporated into the additively manufactured workpiece (e.g. is adhesively bonded into layers of the additively manufactured workpiece), can provide the digital signature and/or the unique identification value and/or the identification number, for example. This is advantageous in particular for facilitating a direct association between the workpiece and the digital signature and/or the unique identification value and/or the identification number.

In a further embodiment of the method, the workpiece data and/or the unique identification value and/or the/an identification number are included in the digital certificate.

In a further embodiment of the method, the unique identification value and/or the identification number is/are used to associate the additively manufactured workpiece with a digital twin and/or vice versa.

The method is advantageous for in particular facilitating the processing of the digital certificate, or the assignment of the digital certificate to the additively manufactured workpiece is facilitated thereby.

In a further embodiment of the method, the digital certificate is provided to the service provider, and the digital certificate is provided to the service provider in particular following payment of a license fee to the rights holder.

In a further embodiment of the method, the digital certificate is provided by a digital twin.

The method is advantageous for in particular facilitating the settlement of license fees to the additively manufactured workpiece.

The method is advantageous for in particular facilitating the processing of the digital certificate, or the assignment of the digital certificate to the additively manufactured workpiece is facilitated thereby.

In a further embodiment of the method, the digital certificate can be used to check whether an additively manufactured workpiece authorized by the rights holder is involved.

This can be realized for example by virtue of the additively manufactured workpiece (including individual features) being captured by means of a further capture device (e.g. 3D_S1), in particular by a purchaser of the workpiece, and in particular the workpiece data accordingly being captured (analogously to claim 1). Thereafter, for example the digital certificate can be checked for its authenticity (e.g. by the purchaser of the workpiece), and/or in particular it is possible to check whether the further workpiece data (that is to say those from a purchaser) are concordant with the workpiece data stored in the digital certificate or comply with the tolerance range (this can be done e.g. by the purchaser of the workpiece).

In accordance with a further aspect, embodiments of the invention relate to an apparatus for identifying an additively manufactured workpiece, having:
a capture device for capturing the additively manufactured workpiece, wherein workpiece data about individual features of the additively manufactured workpiece are captured;
an assigning module for assigning the workpiece data to the additively manufactured workpiece;
a comparison module for comparing the workpiece data with reference data for the additively manufactured workpiece;
a generating module for generating a digital certificate if dissimilarities in the workpiece data in comparison with reference data are within a prescribed tolerance range.

In a further embodiment of the apparatus, the apparatus comprises at least one further module or multiple further modules for performing the method according to embodiments of the invention (or one of the embodiments of the method).

In addition, a computer program product (non-transitory computer readable storage medium having instructions, which when executed by a processor, perform actions) having program commands for performing the cited methods according to embodiments of the invention is claimed, wherein one of the methods according to embodiments of the invention, all the methods according to embodiments of the invention or a combination of the methods according to embodiments of the invention is/are respectively performable by means of the computer program product.

Additionally, a variant of the computer program product having program commands for configuring a creating device, for example a 3D printer, a computer system or a production machine suitable for creating processors and/or devices, is claimed, wherein the creating device is configured with the program commands such that the cited apparatus according to embodiments of the invention is created.

Furthermore, a providing apparatus for storing and/or providing the computer program product is claimed. The providing apparatus is for example a data carrier that stores and/or provides the computer program product. Alternatively and/or additionally, the providing apparatus is for example a network service, a computer system, a server system, in particular a distributed computer system, a cloud-based computer system and/or virtual computer system that stores and/or provides the computer program product may be in the form of a data stream.

This providing takes place for example as a download in the form of a program data block and/or command data block, as a file, in particular as a download file, or as a data stream, in particular as a download data stream, of the complete computer program product. However, this providing can for example also take place as a partial download consisting of multiple parts and in particular downloaded via a peer-to-peer network or provide as a data stream. Such a computer program product is read into a system for example by using the providing apparatus in the form of the data carrier and executes the program commands, so that the method according to embodiments of the invention is executed on a computer or configures the creating device such that the apparatus according to embodiments of the invention is created.

### BRIEF DESCRIPTION

Some of the embodiments will be described in detail, with reference to the following figures, wherein like designations denote like members, wherein:

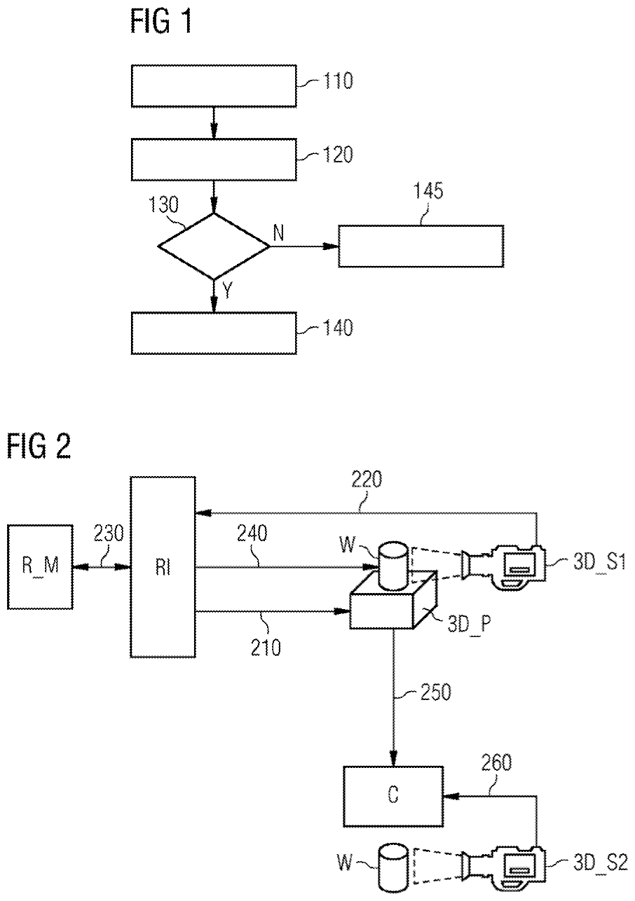

FIG. 1 shows a first exemplary embodiment of the invention as a flowchart;

FIG. 2 shows a further exemplary embodiment of the invention; and

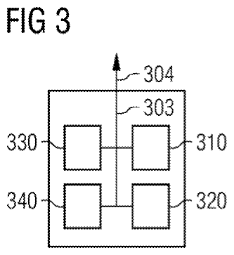

FIG. 3 shows a further exemplary embodiment of the invention.

### DETAILED DESCRIPTION

Unless indicated otherwise or indicated already, the exemplary embodiments below have at least one processor and/or one memory unit in order to implement or carry out the method.

Moreover, in particular a (relevant) person skilled in the art, with knowledge of the method claim/method claims, is of course aware of all routine possibilities for producing products or possibilities for implementation in the prior art, and so there is no need in particular for independent disclosure in the description. In particular, these customary realization variants known to a person skilled in the art can be produced exclusively by hardware (components) or exclusively by software (components). Alternatively, and/or additionally, a person skilled in the art, within the scope of his/her expert ability, can chose to the greatest possible extent arbitrary combinations according to embodiments of the invention for hardware (components) and software (components) in order to implement realization variants according to embodiments of the invention.

A combination according to embodiments of the invention for hardware (components) and software (components) can occur in particular if one portion of the effects according to embodiments of the invention is brought about exclusively by special hardware (e.g. a processor in the form of an ASIC or FPGA) and/or another portion by the (processor- and/or memory-aided) software.

In particular, in view of the high number of different realization possibilities, it is impossible and also not helpful or necessary for the understanding of embodiments of the invention to name all these realization possibilities. In this respect, in particular all the exemplary embodiments below are intended to demonstrate merely by way of example a few ways in which in particular such realizations of the teaching according to embodiments of the invention could be manifested.

Consequently, in particular the features of the individual exemplary embodiments are not restricted to the respective exemplary embodiment, but rather relate in particular to embodiments of the invention in general. Accordingly, features of one exemplary embodiment may also serve as features for another exemplary embodiment, in particular without this having to be explicitly stated in the respective exemplary embodiment.

FIG. 1 shows a first exemplary embodiment of the invention as a flowchart for the method according to embodiments of the invention for identifying an additively manufactured workpiece. The method is may be performed in computer-aided fashion. The method can also be used to authorize or certify the additively manufactured workpiece, for example by means of the digital certificate. In particular, the method according to embodiments of the invention can be used for a posteriori (that is to say following production of the additively manufactured workpiece) licensing of the additively manufactured workpiece.

First, the additively manufactured workpiece is produced by a service provider, e.g. by using a 3D printing method. Model data necessary for manufacturing the additively manufactured workpiece can be provided for example by a rights holder of the model data via a web platform or the rights holder transmits the model data to the service provider by means of other communication means (e.g. via e-mail). The model data may also be cryptographically protected (e.g. by a digital signature/a digital certificate of the rights holder), for example. Additionally, or alternatively, an encryption method could be used in order to cryptographically protect the model data.

The method comprises a first method step 110 for capturing the additively manufactured workpiece by means of a capture device, wherein workpiece data about individual features of the additively manufactured workpiece are captured. This method step can be performed by the service provider, for example. The capture device can be for example a 3D scanner, a surface scanner or a microscope, which are able to capture at least one portion of the surface of the additively manufactured workpiece. In particular, the at least one portion of the surface is prescribed (e.g. by the rights holder), and may be prescribed by the model data.

In particular, e.g. a 3D scanner can also capture the entire surface of the additively manufactured workpiece.

The individual features can be for example random artefacts of the production process (e.g. scratches and irregularities on the surface of the additively manufactured workpiece). By way of example, it is alternatively conceivable for these individual features to be prescribed features produced during manufacture. To this end, the model data can contain applicable information, for example. In a further alternative, the individual features are a combination of random artefacts and prescribed features.

The workpiece data may be transmitted from the service provider to the rights holder.

The method then comprises a second method step 120 for assigning the workpiece data to the additively manufactured workpiece. This assignment may be performed by the rights holder. This can involve for example a workpiece data being taken as a basis for forming a unique identification value that provides a digital fingerprint, for example.

The assigning can be performed for example by virtue of the workpiece data being stored for example in a digital twin (e.g. an instantiation of the digital twin instance with a processor, which instance is associated with the workpiece) of the currently measured workpiece. In other words, the workpiece data can be stored for example in an instance of a data structure (e.g. the applicable digital twin of the workpiece) that is associated with the workpiece.

The method comprises a third method step 130 for comparing the workpiece data with reference data for the additively manufactured workpiece. This involves for example the rights holder comparing the workpiece data with the reference data. The reference data can be the model data or data of a reference model, for example.

The method comprises a fourth method step 140 for generating a digital certificate if dissimilarities in a workpiece data in comparison with the reference data are within a prescribed tolerance range (indicated by Y in FIG. 1). This may take place during the comparing (step 130).

If the dissimilarities exceed the tolerance range (depicted by N in FIG. 1), a certificate is not created (step 145). These method steps 140 and/or 145 can be performed by the rights holder, for example. The tolerance range can be provided by threshold values, for example. Alternatively, or additionally, it would for example also be possible to include the degree of the established concordance/quality of the workpiece data in comparison with the reference data in the certificate as well. In this variant, a certificate could then in particular be issued in each case possibly with a statement that the workpiece is not sufficiently concordant with the reference data (that is to say that the tolerance range is exceeded).

In other words, the certificate could for example also be generated in the negative case and the test result (negative/positive) could be documented in the certificate. (Even if the certificate with the negative test result is never used again as a result). If need be, the degree of dissimilarity can also be documented in the certificate. The acceptance range can then be chosen by the end user. This could make sense for example if the manufacturer/rights holder contemplates manufacturer clearance for less demanding areas of use e.g. still sells the workpiece as a defective copy.

An example would be that depressions (random artefacts) of up to 0.5 mm (tolerance range) are admissible as a maximum for surface irregularities at least in a subregion of the surface of the additively manufactured workpiece. If the additively manufactured workpiece has a depression of 0.7 mm, a digital certificate is not issued. If the additively manufactured workpiece has e.g. only depressions of up to 0.3 mm, the digital certificate is issued.

The digital certificate is then provided for the additively manufactured workpiece.

This can involve the digital certificate being provided for example to the service provider (e.g. provided as a download), in particular after the service provider has paid a license fee to the rights holder.

In one variant, the unique identification value and/or the identification number is/are applied to the additively manufactured workpiece. This can be done by the service provider, for example.

In a further variant, the unique identification value and/or the identification number is/are used to associate the additively manufactured workpiece with a digital twin and/or a digital twin is associated with the additively manufactured workpiece.

In a further variant, the digital certificate is provided by a digital twin.

The digital certificate can be used in particular to check (e.g. by a purchaser of the additively manufactured workpiece) whether an additively manufactured workpiece authorized by the rights holder is involved.

In a further variant, the unique identification value and/or the identification number will be applied to the additively manufactured workpiece as a sticker, a security seal. Alternatively, or additionally, the unique identification value and/or the identification number can also be incorporated into the workpiece (e.g. as an inscription, a stamped digit sequence, etc.).

In a further variant, an RFID chip (e.g. included in a security seal), which is adhesively bonded to the additively manufactured workpiece (e.g. as a security seal) or incorporated into the additively manufactured workpiece (e.g. is adhesively bonded into layers of the additively manufactured workpiece), provides the digital signature and/or the unique identification value and/or the identification number, for example. The RFID chip may be able to be written to only once, which means that the data (e.g. the digital signature and/or the unique identification value and/or the identification number) can be stored on the RFID chip by the service provider (after the latter has obtained the data), for example, and the data may be stored unalterably.

The proposed method can be used both in addition and as an alternative to a priori (e.g. a license is sold to the service provider before manufacture) licensing methods.

The exemplary embodiment from FIG. 1 is now put in more concrete terms on the basis of the exemplary embodiment of FIG. 2. Accordingly, features of the first exemplary embodiment and of the variants thereof (FIG. 1) and of the second exemplary embodiment and of the variants thereof (FIG. 2) can be combined with one another.

First, for example a rights holder (e.g. a manufacturer of spares) makes its design available 210 (e.g. as model data) and the additively manufactured workpiece W (alternatively referred to just as workpiece W) is created by the service provider in situ on a 3D printer 3D_P.

Subsequently, the workpiece W is measured using a (suitable) 3D scanner 3D_S1. In particular, this involves the workpiece data that individually identify the workpiece W within the framework of the manufacturing tolerance or of the manufacture (“fingerprint”, e.g. surface structure) being captured. These are for example the individual features of the workpiece W. A unique identification value can be formed from the workpiece data to form a digital fingerprint, for example, e.g. by virtue of the workpiece data being used to form a cryptographic hash or a cryptographic checksum or a hash or a checksum.

In this case, a suitable capture device/3D scanner can be understood to mean for example a capture device/3D scanner whose optical and/or spatial resolution is adequate to capture random artefacts of the production method. Accordingly, the optical and/or spatial resolution of the capture device/3D scanner is higher than a manufacturing accuracy of the additive manufacturing process (also called additive manufacturing) used to produce the additively manufactured workpiece W.

The captured workpiece data may be selected such that deliberate influencing of the production or manufacture is not possible or is possible only with considerable effort (i.e. the artefacts of the production method are supposed to be random). In other words, the individual features are random artefacts whose optical and/or spatial resolution or size is greater than the manufacturing accuracy of the additive manufacturing process used to produce the additively manufactured workpiece W.

The workpiece data (e.g. transmitted as a measurement data record) are then sent to the rights holder (manufacturer) (step 220).

The rights holder compares the workpiece data against the reference data R_M (e.g. by using a reference model) (step 230).

If the workpiece data are within a required tolerance range, the digital certificate (alternatively also referred to just as certificate) is created (step 240).

The certificate confirms in particular that the workpiece data are in the tolerance range of the reference model/the reference data R_M and were thus authorized by the rights holder.

The digital certificate can include for example a digital signature of the rights holder for the workpiece data about the individual features of the workpiece W (“fingerprint”). Alternatively, or additionally, the digital certificate can comprise the fundamental workpiece data in order to facilitate a later comparison. Besides these, the certificate can include further auxiliary data (e.g. an identification number openly printed on the workpiece) that facilitate a later association between the workpiece W and the digital certificate.

In one variant, this can be a reference to the digital twin of the workpiece W.

In a further variant, the certificate may be provided only after the license costs are settled (that is to say e.g. the service provider has paid a license fee to the rights holder.

The workpiece W maybe handed over 250 to the customary/purchaser together with the certificate. The certificate can be provided via the digital twin of the workpiece W, for example.

The customer/purchaser of the workpiece W can take the certificate as a basis for deciding whether a workpiece W authorized by the rights holder is involved (step 260). In particular in safety-sensitive areas, procedural regulations can prevent unauthorized workpieces from being used.

To this end, the purchaser can check the digital certificate for its authenticity. Additionally, or alternatively, the purchaser can use a further suitable 3D scanner 3_S2 to capture further workpiece data and can compare these against the data from the digital certificate in order to check the authenticity. If the further workpiece data and the data of the digital certificate (e.g. the workpiece data in the digital certificate, unique identification value, identification number, etc.) are concordant, then the purchaser establishes that the workpiece W is authentic. If the further workpiece data and the data of the digital certificate are not concordant, the purchaser can approach the rights holder and inform it about the potentially fake workpiece W. For this check, the purchaser may also calculate a further unique identification value on the basis of the workpiece data analogously to the description cited above. The purchaser then compares for example the unique identification value with the further unique identification value in order to check the authenticity.

In a further variant, the model data comprise details concerning structures/areas of the workpiece W in which an increased manufacturing tolerance/variation in specific technological parameters (e.g. manufacturing parameters) within a specific range is functionally admissible. Such structures/areas or regions of the workpiece W may be used to capture the workpiece data about the individual features of the additively manufactured workpiece W.

In a further variant, the individual features of the additively manufactured workpiece W are not directly the result of the additive manufacturing process. Instead, the additive manufacturing process involves a location on the workpiece W being prepared/machined such that a location having the individual features can subsequently be produced there (e.g. a predetermined breaking point) by a further manufacturing process (for example with a partly random outcome).

In a further variant, the workpiece W itself is used as a carrier of the certificate. By way of example, after a first manufacturing step has taken place, the workpiece data are measured/captured/ascertained at one location (e.g. the at least one part of the surface) on the workpiece W and, during a second manufacturing step, the certificate or the signature of the certificate is introduced into the workpiece/applied to the workpiece.

FIG. 3 shows a further exemplary embodiment of the invention as an apparatus for identifying an additively manufactured workpiece.

The apparatus comprises a capture device 310, an assigning module 320, a comparison module 330, a generating module 340 and an optional first communication interface 304, which are communicatively connected to one another via a first bus 303.

The apparatus can for example additionally also comprise a further or multiple further component(s), such as for example a processor, a memory unit, an input device, in particular a computer keyboard or a computer mouse, and a display device (e.g. a monitor). The processor can comprise multiple further processors, for example, the further processors each providing one or more of the modules, for example. Alternatively, the processor provides in particular all the modules of the exemplary embodiment. The further components can likewise be communicatively connected to one another via the first bus 303, for example.

The processor can be for example an ASIC provided on an application-specific basis for the functions of a respective module or of all the modules of the exemplary embodiment (and/or of further exemplary embodiments), the program component or the program commands being provided as integrated circuits, in particular. The processor can for example also be an FPGA that is configured in particular by means of the program commands such that the FPGA performs the functions of a respective module or of all the modules of the exemplary embodiment (and/or of further exemplary embodiments).

The capture device 310 is configured to capture the additively manufactured workpiece, with workpiece data about individual features of the additively manufactured workpiece being captured.

The capture device 310 can be provided as a 3D scanner or as a surface scanner or as a surface microscope, for example.

The assigning module 320 is configured to assign the workpiece data to the additively manufactured workpiece.

The assigning module 320 can be implemented or provided by means of the processor, the memory unit and a second program component, for example, with for example execution of program commands of the second program component configuring the processor in such a way, or the program commands having configured the processor in such a way, that the workpiece data are assigned.

The comparison module 330 is configured to compare the workpiece data with reference data for the additively manufactured workpiece.

The comparison module 330 can be implemented or provided by means of the processor, the memory unit and a third program component for example, with for example execution of program commands of the third program component configuring the processor in such a way, or the program commands having configured the processor in such a way, that the workpiece data are compared.

The generating module 340 is configured to generate a digital certificate if dissimilarities in a workpiece data in comparison with the reference data are within a prescribed tolerance range.

The generating module 340 can be implemented or provided by means of the processor, the memory unit and a fourth program component, for example, with for example execution of program commands of the fourth program component configuring the processor in such a way, or the program commands having configured the processor in such a way, that the digital signature is calculated.

In further embodiments of the apparatus, the apparatus comprises at least one further module or multiple further modules for performing the method according to embodiments of the invention (or one of the embodiments/variants thereof).

The executing of the program commands of the respective modules can be effected for example by means of the processor itself and/or by means of an initialization component, for example a loader or a configuration component.

Although the present invention has been disclosed in the form of preferred embodiments and variations thereon, it will be understood that numerous additional modifications and variations could be made thereto without departing from the scope of the intention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A method for identifying an additively manufactured workpiece of the method comprising:
a) capturing the additively manufactured workpiece by means of a capture device, wherein workpiece data about individual features of the additively manufactured workpiece are captured;
b) assigning the workpiece data to the additively manufactured workpiece;
c) comparing the workpiece data with reference data for the additively manufactured workpiece;
d) generating a digital certificate if dissimilarities in the workpiece data in comparison with the reference data are within a prescribed tolerance range;
e) forming a unique identification value on a basis of the workpiece data, wherein the workpiece data and/or the unique identification value and/or the/an identification number are included in the digital certificate, and
f) associating the additively manufactured workpiece with a digital twin and/or vice versa by means of the unique identification value and/or the identification number.

2. The method as claimed in claim 1, wherein:
producing of the additively manufactured workpiece and the capturing are performed by a service provider,
the assigning, the comparing and the generating are performed by a rights holder for the additively manufactured workpiece,
wherein the service provider to this end transmits the workpiece data to the rights holder.

3. The method as claimed in claim 1, wherein the individual features are random artefacts of the production process.

4. The method as claimed in claim 1, wherein the digital certificate indicates that the additively manufactured workpiece complies with the tolerance range.

5. The method as claimed in claim 1, wherein the unique identification value and/or the identification number are applied to the additively manufactured workpiece.

6. The method as claimed in claim 2, wherein:
the digital certificate is provided to the service provider,
the digital certificate is provided to the service provider after payment of a license fee to the rights holder.

7. The method as claimed in claim 1, wherein the digital certificate is provided by a digital twin.

8. The method as claimed in claim 1, wherein the digital certificate is used to check whether an additively manufactured workpiece authorized by the rights holder is involved.

9. An apparatus for identifying an additively manufactured workpiece, comprising:
a capture device for capturing the additively manufactured workpiece, wherein workpiece data about individual features of the additively manufactured workpiece are captured;
an assigning module for assigning the workpiece data to the additively manufactured workpiece;
a comparison module for comparing the workpiece data with reference data for the additively manufactured workpiece;
a generating module for generating a digital certificate if dissimilarities in the workpiece data in comparison with reference data are within a prescribed tolerance range,
wherein a unique identification value is formed on a basis of the workpiece data, wherein the workpiece data and/or the unique identification value and/or the/an identification number are included in the digital certificate, and wherein the additively manufactured workpiece is associated with a digital twin and/or vice versa by means of the unique identification value and/or the identification number.

10. A computer program product, comprising a computer readable hardware storage device having computer readable program code stored therein, said program code executable by a processor of a computer system to implement a method as claimed in claim 1.

11. A computer program product having program commands for a creating device that is configured by means of the program commands to create the apparatus as claimed in claim 9.

12. A providing apparatus for the computer program product as claimed in claim 10, wherein the providing apparatus stores and/or provides the computer program product.
